(19) United States
(12) Patent Application Publication
(10) Pub. No.: US 2025/0273851 A1
(43) Pub. Date: Aug. 28, 2025

(54) AN ANTENNA CANOPY SYSTEM DESIGN FOR REDUCTION OF ATMOSPHERIC SELF-INTERFERENCE

(71) Applicant: JIO PLATFORMS LIMITED, Ahmedabad (IN)

(72) Inventors: Pradeep Kumar BHATNAGAR, Navi Mumbai (IN); Praveen Kumar PENTA, Navi Mumbai (IN); Vijay Mohan VERMA, Navi Mumbai (IN); Brijesh I. SHAH, Navi Mumbai (IN); Aayush BHATNAGAR, Navi Mumbai (IN)

(73) Assignee: JIO PLATFORMS LIMITED, Ahmedabad (IN)

(21) Appl. No.: 18/879,020

(22) PCT Filed: Sep. 30, 2023
(86) PCT No.: PCT/IB2023/059827

§ 371 Date: Dec. 26, 2024

(30) Foreign Application Priority Data
Sep. 30, 2022 (IN) 202221056427

(51) Int. Cl. H01Q 1/52; H01Q 1/24

(52) U.S. Cl. CPC H01Q 1/526; H01Q 1/246

(57) ABSTRACT

The present disclosure provides for a system facilitating reduction of network self-interference. The system is equipped with an innovative antenna canopy structure which can be mounted on the top of a base station antenna to suppress an RF signal level propagating through upper side-lobes of the base station antenna above the horizon. The antenna canopy structure further ensures that there is no effect of wind load when mounted in the antenna top and also to reduce its weight.

### FIELD OF INVENTION

The present invention relates generally to wireless telecommunication technology, and more particularly to a system for reducing interference in a network.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Atmospheric self-interference while receiving and transmitting radio frequency (RF) signals is one of the causes for obtaining poor quality of information from the RF signals. The high gain directional antennas are being used in the cellular network to concentrate the RF energy of the Base Station within a specific cell area. The antenna beam includes the directive main lobe, back lobe and multiple side-lobes. The objective of the main lobe is to provide a coverage in the desired cell region and the energy emanating from the side-lobes and back-lobe is undesired and causes interferences. Especially, the tropospheric duct interference is one of the major issues in any Time-division duplexing (TDD) based cellular networks. The ducting is created naturally in the atmosphere when temperature inversion occurs generally over large bodies of water or over wide-open spaces. Normally, the air is warmer near the ground and cooler as the altitude increases. When the temperature inversion occurs, the cool air becomes trapped under the warm air and the boundary between the two layers of the air reflects signals when their angle of incidence is in the appropriate range. The ducting phenomenon causes the RF signal radiated from the antenna to get trapped in this duct, undergo multiple reflections with minimal attenuation, can travel to longer distances of greater than 200 kms and create interference to the cellular sites located at these distances. This phenomenon is similar to the light signal propagating in fiber optic cable where signal gets transmit through the fiber with multiple internal reflections without any significant attenuation. The impact of Tropospheric Interference is so huge that a single Aggressor located at one site can impact thousands of far located Victim sites. In TDD network, the Downlink signal from the Aggressor site will severely interfere the Uplink signals of the Victim sites, there by resulting huge call drops and degrading the Uplink KPIs. The cells affected due to this interference is seen to be more during the winter season because to the favourable weather condition to form duct in Troposphere.

Tropospheric interference is badly impacting the network performance in affected Victim cells. There have been several measures proposed over a period to reduce the cells which has been impacted due to interference such as changing SSF configuration at Victim cells and this is effective for Aggressor and Victim sites distance upto 150 Kms. Moreover, this is not an effective approach since the traffic and the user throughput gets degraded. Another measure is to electrically down tilt the antenna at Aggressor cells and this will alleviate the interference to an extent but shirks the coverage of the implemented cells. The above techniques are based on reactive approach, where the action is taken after the Aggressor and Victim cells are identified. The RF energy leaking from the side-lobes above the main-lobe directly goes towards the sky and is the main candidate for the ducting interference. Normally, the upper side-lobes are being suppressed by more than 15 dB from the main lobe. Even with the very good and costly antenna design, the side-lobes cannot be further reduced by more than 2-3 dB in the entire frequency band and electrical tilt range of the antenna. There has also been no approach to suppress the Tropospheric ducting interference permanently.

Hence, there is a requirement in the art for a system that will lead to reduction of atmospheric self-interference in the RF signals.

### OBJECTS OF THE PRESENT DISCLOSURE

Some of the objects of the present disclosure, which at least one embodiment herein satisfies are as listed herein below.

It is an object of the present disclosure to provide an antenna canopy that will diminish the Tropospheric duct interference.

It is an object of the present disclosure to provide an antenna canopy that will significantly reduce the Upper and grating lobes of the antenna and thereby reduce the amount of RF signal or power entering into duct region.

It is an object of the present disclosure to provide a system that prevents degradation in the antenna electrical and main lobe radiation pattern performance with Canopy structure.

It is an object of the present disclosure to provide an antenna canopy structure that is easy to install on the top of the antenna without any additional mounting bracket gear.

It is an object of the present disclosure to provide an antenna canopy structure that requires no demounting of the base station antenna on the tower for installing the antenna canopy.

It is an object of the present disclosure to provide an antenna canopy structure that has no additional effect of wind load on tower.

It is an object of the present disclosure to provide an antenna canopy structure that minimizes the weight of the antenna canopy structure.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for reducing network self-interference. The system may include an antenna canopy mounted on top of a base station antenna for receiving and transmitting a set of radio frequency (RF) signals to one or more far end cell sites. The system may also include one or more computing devices operatively coupled to one or more processors, the one or more processors operatively coupled to the antenna through a network. The one or more processors may be further coupled with a memory that may store instructions which when executed by the one or more processors, may cause the system to receive, by an antenna canopy, the set of RF signals from the atmosphere and then suppress an RF signal level propagating through upper side-lobes of the base station antenna from the set of RF signals received. The filtered set of RF signals may be transmitted to the one or more far end cell sites and then detect, by one or more processors, an antenna electrical and main lobe radiation pattern of the suppressed set of RF signals.

In an embodiment, the system may be further configured to reduce upper and grating lobes of the base station antenna to prevent an amount of an RF signal entering into a duct region of the atmosphere without degradation in the Antenna Electrical and Main lobe radiation pattern.

In an embodiment, the system may be further configured to identify, by the one or more processors, one or more aggressor cells and one or more victim cells.

In an embodiment, the system may be further configured to alleviate interference in the one or more Aggressor cells.

In an embodiment, the system may be further configured to reduce the number of victim cells based on the alleviation of interference in the one or more Aggressor cells without affecting traffic and user throughput.

In an embodiment, the system may be further configured to reduce a Tropospheric interference permanently.

In an aspect, the present disclosure provides for an antenna canopy for reducing network self-interference. The antenna canopy may include a mounting bracket that may include one or more structures to mount the mounting bracket on top of a base station antenna. The mounting bracket may be of a predefined shape and size. The antenna canopy may also include a metal frame connected in the inner sides of the mounting bracket and a metal sheet configured to be attached to the metal frame. In an embodiment, the metal sheet may include a plurality of cut outs of a predefined shape. The plurality of cut outs may be spread out periodically, and designed as a mesh type structure such that one or more predefined frequencies of a set of RF signals that cause interference in the set of RF signals are filtered by the plurality of cut outs.

In an embodiment, filtering by the plurality of cut outs reduces a sidelobe or grating lobe power level that ceases a leakage of an RF signal into a duct region of the atmosphere.

In an embodiment, the antenna canopy may be attachable or detachable without having to demount the base station antenna.

In an embodiment, the mesh type structure may prevent additional effect of wind on the base station.

In an embodiment, the mesh type structure may minimize weight of the antenna canopy.

In an embodiment, the predefined shape of the plurality of cut outs may be square, diamond, hexagonal, circular, parallelogram, and L shaped.

In an aspect, the present disclosure provides a user equipment (UE). The user equipment comprises a processor, a memory, a network antenna in the user equipment. The network antenna establishes a communication channel by receiving one or more signals from one or more cell sites to said UE. Furthermore, the one or more cell sites are victim cells or aggressor cells. The UE further comprises a receiver. The receiver may be configured to adapt filtered signals coming from optimized cells and optimization is based on filtration of interference signals; and a transmitter, configured for uplink transmission from the user equipment. The uplink transmission is an optimised signal transmission.

A non-transitory computer-readable medium comprising processor-executable instructions that cause a processor to receive a set of radio frequency (RF) signals from an atmosphere, suppress RF signal level propagating through upper side-lobes of a base station antenna (108) from the set of RF signals received, transmit the filtered set of RF signals to one or more far end cell sites, and detect an antenna electrical and main lobe radiation pattern of the suppressed set of RF signals.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an exemplary network architecture of a proposed antenna canopy system, in accordance with an embodiment of the present disclosure.

FIG. 1B illustrates an exemplary network architecture diagram depicting a system for identifying at least one aggressor cell, in accordance with exemplary embodiments of the present invention.

FIG. 1C illustrates an exemplary proposed antenna canopy structure, in accordance with an embodiment of the present disclosure.

FIG. 1D illustrates an exemplary signal flow diagram for identifying at least one aggressor cell, in accordance with exemplary embodiments of the present invention.

FIG. 2 illustrates an exemplary representation of the processor modules of the proposed system, in accordance with an embodiment of the present disclosure.

FIG. 3A illustrates an exemplary representation of the proposed antenna canopy installed on a base station antenna, in accordance with an embodiment of the present disclosure.

FIG. 3B illustrates an exemplary representation of a frame structure to attach the metal sheet and L-shape bracket, in accordance with an embodiment of the present disclosure.

FIGS. 4A-4B illustrate exemplary representations of Grating lobe level comparison with and without the Antenna Canopy.

FIGS. 5A-5B illustrate exemplary representations of reduction in Victim sites count-with and without Antenna Canopy.

FIG. 6 illustrates an exemplary representation of an Antenna Canopy installation in field.

FIG. 7 illustrates a flow diagram representation of a method for detecting an antenna electrical and main lobe radiation pattern of the suppressed set of Radio Frequency (RF) signals, in accordance with an embodiment of the present disclosure.

FIG. 8 illustrates a flow chart of the process at UE for uplink transmission of optimized signal, in accordance with an embodiment of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

### Functional Descriptions of System and Sub-System

A person skilled in the art would be aware that in a high gain directional antennas are being used in the cellular network to concentrate the RF energy of the Base Station within a specific cell area. The antenna beam includes the directive main lobe, back lobe and multiple side-lobes. The objective of the main lobe is to provide a coverage in the desired cell region and the energy emanating from the side-lobes and back-lobe is undesired and causes interferences. The RF energy leaking from the side-lobes above the main-lobe directly goes towards the sky and is the main candidate for the ducting interference. Normally, the upper side-lobes are being suppressed by more than 15 dB from the main lobe. Even with the very good and costly antenna design, the side-lobes cannot be further reduced by more than 2-3 dB in the entire frequency band and electrical tilt range of the antenna.

### Proposed Solution

In an aspect, the present disclosure provides for a system facilitating reduction of network atmospheric self-interference. The system is equipped with an innovative antenna canopy structure which can be mounted on the top of a base station antenna to suppress an RF signal level propagating through upper side-lobes of the base station antenna above the horizon. The antenna canopy structure further ensures that there is no effect of wind load when mounted in the antenna top and also to reduce its weight.

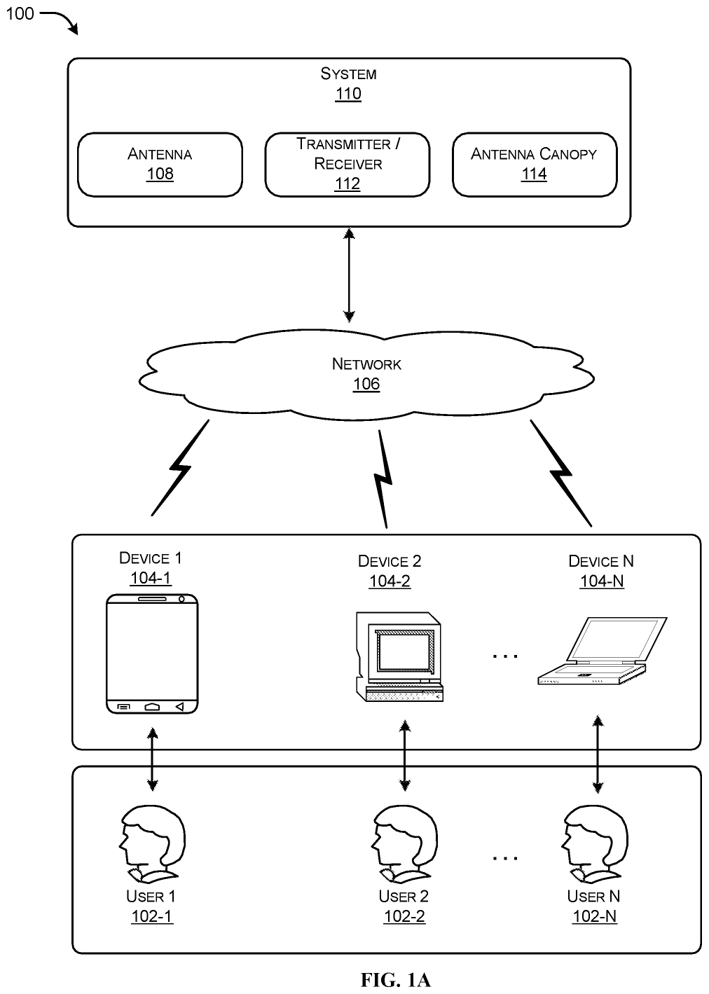

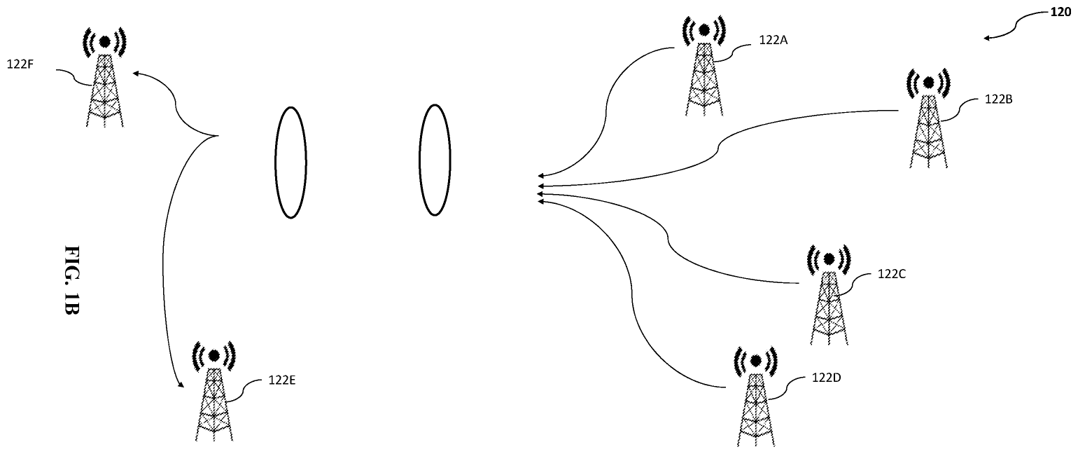

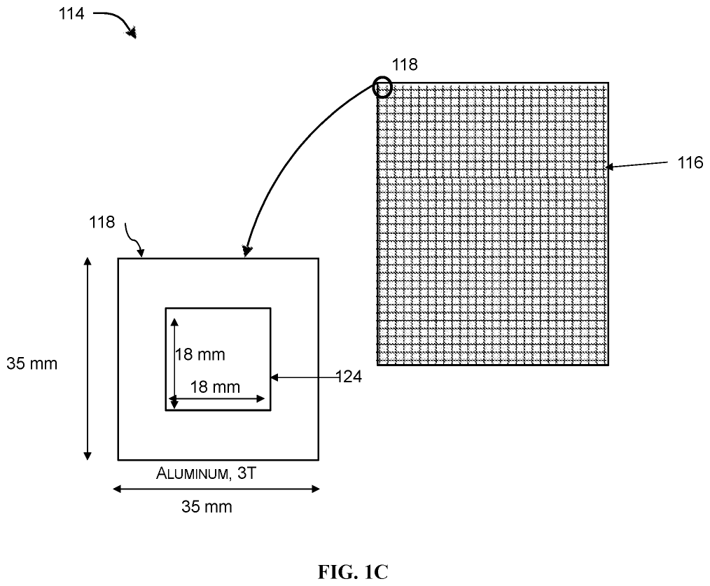

Referring to FIG. 1A that illustrates an exemplary network architecture of a proposed antenna canopy system, in accordance with an embodiment of the present disclosure. The network architecture (100) may include a base station antenna (108) operatively coupled with a transmitter and a receiver (112) associated with a system (110) that may further be operatively coupled to an antenna canopy (114). The system (110) may be further communicatively coupled to one or more computing devices (104-1, 104-2, . . . , 104-N) (individually referred to as the computing device (104) or user equipment (UE) 104 and collectively referred to as the computing devices (104) or UE 104) associated with one or more users (102-1, 102-2, 102-3, . . . , 102-N) (individually referred to as the user (102) and collectively referred to as the users (102)). The system (110) may be further operatively coupled to mobile devices (not shown in FIG. 1), via network (106).

Further, the system (110) that may be coupled to the antenna canopy (114) that may be mounted on top of the base station antenna (108) for receiving and transmitting a set of radio frequency (RF) signals. The antenna canopy (114) may receive the set of RF signals from the atmosphere.

In an embodiment, the antenna canopy (114) may be configured to suppress a RF signal level propagating through upper side-lobes of the base station antenna (108) from the set of RF signals received and then transmit, the filtered set of RF signals, to the one or more far end cell sites. The system (110) may be further configured to detect an antenna electrical and main lobe radiation pattern of the suppressed set of RF signals.

In an embodiment, the far end cell sites may be communicatively coupled one or more of cell sites in a communication network (106). These far end cell sites may be victim cells.

In an embodiment, the system (110) may be configured to reduce upper and grating lobes of the base station antenna (108) to prevent an amount of the RF signal entering into a duct region of the atmosphere without degradation in the Antenna Electrical and Main lobe radiation pattern. The system (110) may further be configured to identify one or more aggressor cells and one or more victim cells (i.e., far end cell sites) and alleviate interference in the one or more aggressor cells. Based on the alleviation of interference in the one or more Aggressor cells without affecting traffic and user throughput, the system (110) may be further configured to reduce the number of victim cells (i.e., far end cell sites).

In an embodiment, the system (110) may be configured to reduce a Tropospheric interference permanently.

FIG. 1B illustrates an exemplary network architecture diagram (120) depicting a system for identifying at least one aggressor cell, in accordance with exemplary embodiments of the present invention.

The network architecture/system (120 of the present invention further comprises of a first set of base stations (122A, 122B, 122C, 122D) configured to transmit at least one subframe to a second set of base stations (122E, 122F). The at least one subframe may be transmitted by at least one base station of the first set of base stations (122A, 122B, 122C, 122D) to the second set of base stations (122E, 122F). The at least one subframe further comprises of at least one downlink subframe, at least uplink subframe and at least one special subframe. The at least one special subframe further comprises of a downlink pilot time slot, an uplink pilot time slot and a guard period.

Although FIG. 1B shows a limited number of base stations and exemplary components of the base station, in other embodiments, the network may contain additional and any number of base stations, differently arranged, or with additional components than depicted in FIG. 1B. Alternatively, or additionally, one or more components of the network node may perform one or more other tasks described as being performed by one or more other components of the network node.

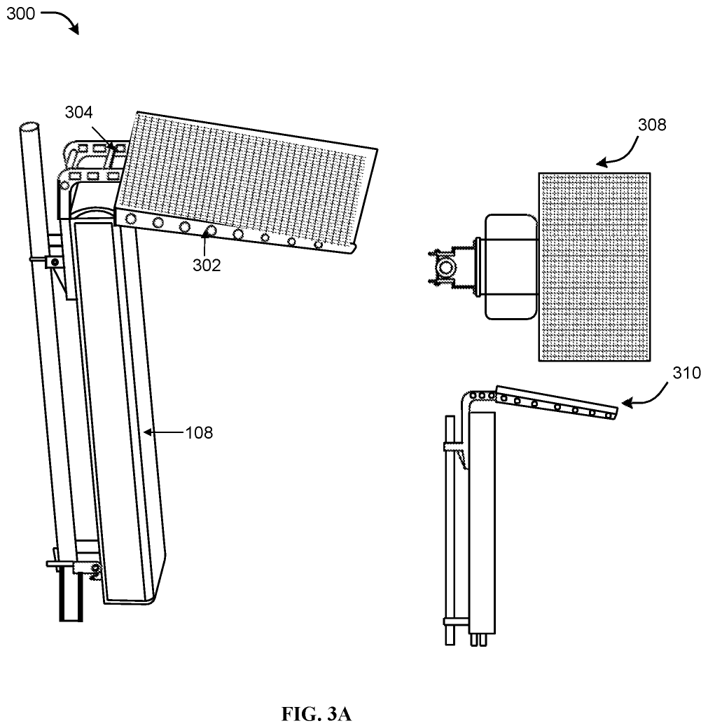

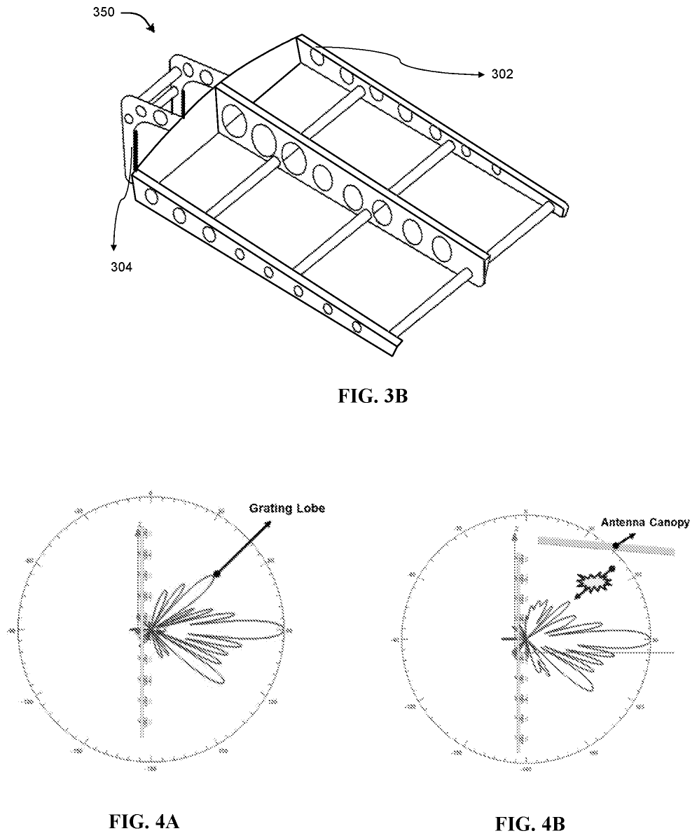

In an aspect, the antenna canopy (114) as illustrated in FIG. 1C may include a mounting bracket (304) (Ref. FIG. 3A) that further may include one or more structures to mount the mounting bracket on top of a base station antenna (108). In an embodiment, the mounting bracket (304) may be of a predefined shape and size. The antenna canopy (114) may further include a metal frame (302) connected in the inner sides of the mounting bracket (304). Furthermore, the antenna canopy (114) may be equipped with a metal sheet (116) configured to be attached to the metal frame (302). The metal sheet (302) may include a plurality of cut outs (118) of a predefined shape. The plurality of cut outs (118) may be spread out periodically, and designed as a mesh type structure such that one or more predefined frequencies of a set of RF signals that cause interference in the set of RF signals are filtered by the plurality of cut outs (118).

In an embodiment, filtering by the plurality of cut outs (118) may reduce a side lobe or grating lobe power level that ceases a leakage of an RF signal into a duct region of the atmosphere. The antenna canopy (114) may be attachable or detachable without having to demount the base station antenna (108). Further, the mesh type structure may prevent additional effect of wind on the base station antenna (108) and minimize weight of the antenna canopy (114). For example, the antenna canopy structure will reduce the side lobe or grating lobe power levels there by ceasing the leakage of RF signal into the duct region.

In an embodiment, the predefined shape of the plurality of cut outs (118) may be square, diamond, hexagonal, circular, parallelogram, L shaped but not limited to the like. In a way of example, and not as a limitation, the plurality of cuts outs (118) as shown in FIG. 1C, may include a cellular rectangular structure with length and breadth of at least 35 mm each that includes an inner cutting having a length and breadth of at least 18 mm each.

In another exemplary embodiment, a server (not shown in FIG. 1) may be included in architecture (100). The server may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the one or more computing devices (104) may communicate with the system (110) via set of executable instructions residing on any operating system, including but not limited to, Android™, iOS™, Kai OS™. and the like. In an embodiment, one or more computing devices (104) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the one or more computing devices (104), and the one or more mobile devices may not be restricted to the mentioned devices and various other devices may be used. A smart computing device may be one of the appropriate systems for storing data and other private/sensitive information.

FIG. 1D illustrates an exemplary signal flow diagram for identifying at least one aggressor cell, in accordance with exemplary embodiments of the present invention.

Referring to FIG. 1D, illustrates an exemplary signal flow diagram for identifying at least one aggressor cell, in accordance with exemplary embodiments of the present invention. In an instance of the present invention, at step (132), a system manager (130) may transmits an E-UTRAN Cell Global Identifier (ECGI) information relating to the one or more one or more base stations of the first set of base stations (122A, 122B, 122C, 122D) in a Downlink Pilot Time Slot (DwPTS) symbols of the first special subframe in a round robin manner. Simultaneously, at step (132), the one or more base stations of the second set of base stations (122E, 122F) start the method for detection of aggressor cells the second special subframe and the third special subframe.

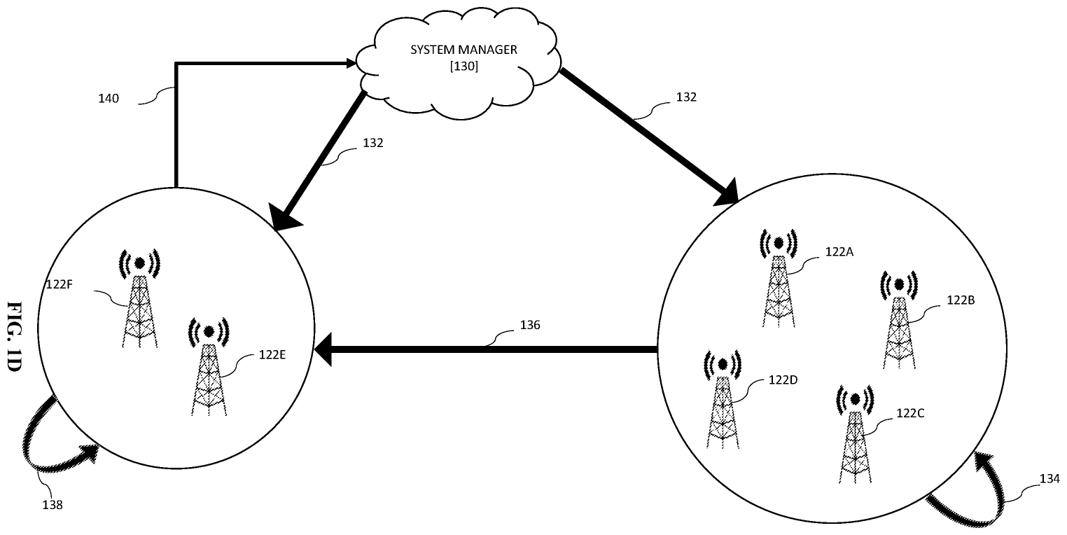

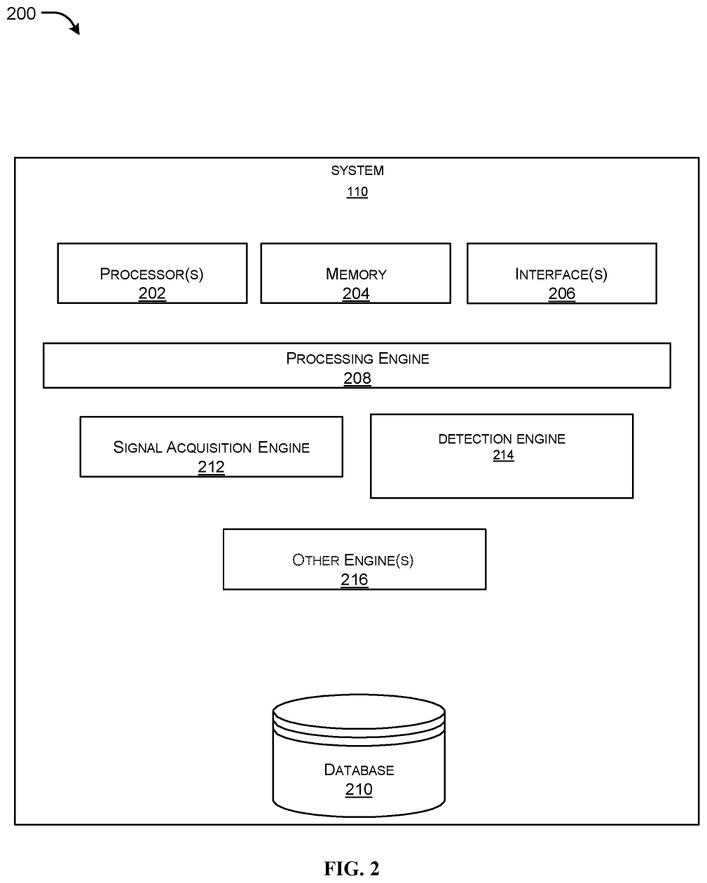

FIG. 2 illustrates an exemplary representation of the proposed system (110), in accordance with an embodiment of the present disclosure.

In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) (206). The interface(s) (206) may also provide a communication pathway for one or more components of the system (110). Examples of such components may include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry. Further, the system (110) may include Machine Learning (ML) modules.

The processing engine (208) may include one or more engines selected from any of a signal acquisition engine (212), detection engine (214), and other engines (216). The signal acquisition engine (212), the detection engine (214) may include Machine Learning (ML) modules. The processing engine (208) may further edge based micro service event processing but not limited to the like.

FIG. 3A illustrates an exemplary representation of the proposed antenna canopy installed on a base station antenna, in accordance with an embodiment of the present disclosure. A frame (302) is used to attach the metal sheet (116) which acts as canopy and a mounting bracket is used to mount the antenna canopy (114) structure on the base station antenna (108). An exemplary top side view (308) of the antenna canopy mounted on the base station antenna shows that the antenna canopy 900 mn long and 700 nm wide. 310 further shows a left side view of the antenna canopy mounted on the base station antenna.

FIG. 3B illustrates an exemplary representation of a frame structure to attach the metal sheet and L-shape bracket, in accordance with an embodiment of the present disclosure. In a way of example and not as a limitation, as shown in FIG. 3B, the mounting bracket (304) can be shaped like an L but not limited to it. The Canopy structure is mounted on the base station antenna itself with the help of a metal frame (302), to ensure the same canopy performance even the antenna is down tilted.

FIGS. 4A-4B illustrate exemplary representations of Grating lobe level comparison with and without the Antenna Canopy. The impact of antenna canopy on the antenna radiation pattern is simulated and observed reduction in grating lobe levels are shown in FIGS. 4A-4B, which are actually causing duct interference. In case of standalone antenna as shown in FIG. 4A, the grating lobes levels are at around 15 dB whereas with the proposed Antenna Canopy structure, as shown in FIG. 4B, the grating lobe levels are reduced by more than 5 dB.

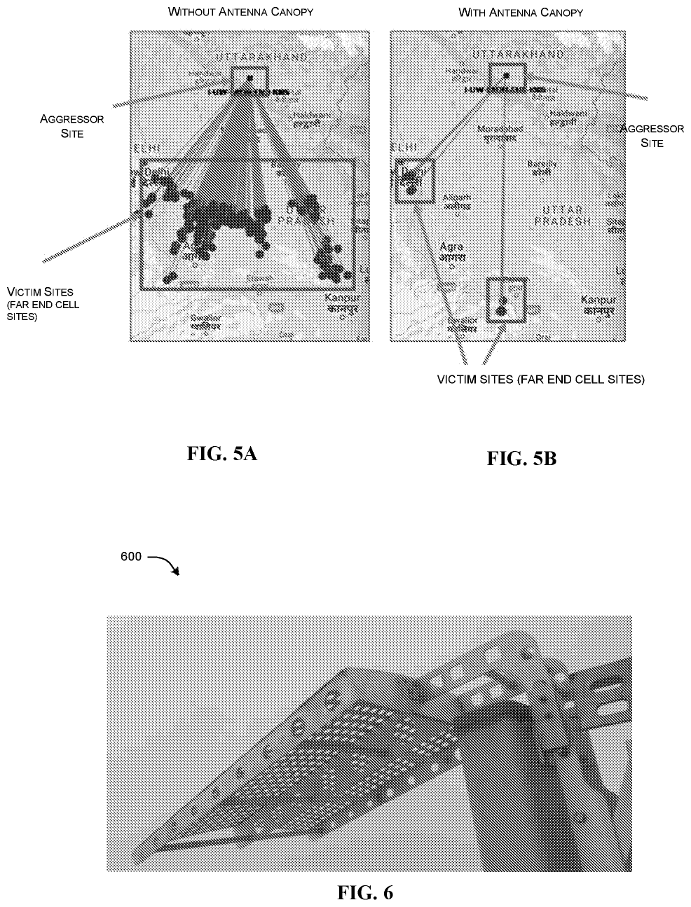

FIGS. 5A-5B illustrate exemplary representations of reduction in Victim sites count—with and without Antenna Canopy. FIG. 5A depicts victim site counts without the antenna canopy while FIG. 5B illustrated victim site counts with the antenna canopy. As can be clearly seen form the FIGS. 5A and 5B, without Antenna Canopy, the Aggressor site is interfering thousands of Victim sites located at faraway distances due to Duct interference. After installing the Antenna Canopy, the Victims count is reduced close to negligible.

FIG. 6 illustrates an exemplary representation of an Antenna Canopy installation in field. The performance of the Antenna Canopy is tested in the real cellular network by installing in one of the Aggressor sites. Without Antenna Canopy, the Aggressor site is interfering thousands of Victim sites located at faraway distances due to Duct interference. After installing the Antenna Canopy, the Victims count is reduced close to negligible. The impact of antenna canopy on the antenna radiation pattern is simulated and observed reduction in grating lobe levels are shown in FIGS. 4A-4B, which are actually causing duct interference. In case of standalone antenna as shown in FIG. 4A, the grating lobes levels are at around 15 dB whereas with the proposed Antenna Canopy structure, as shown in FIG. 4B, the grating lobe levels are reduced by more than 5 dB.

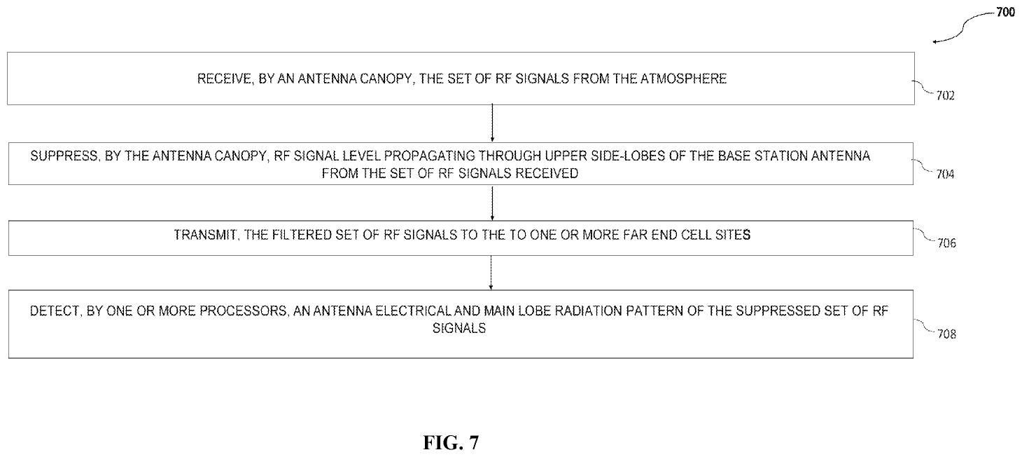

FIG. 7 illustrates a flow diagram representation of a method for detecting an antenna electrical and main lobe radiation pattern of the suppressed set of Radio Frequency (RF) signals, in accordance with an embodiment of the present disclosure.

At step (702), an antenna canopy is configured to receive a set of RF signals from the atmosphere. At step (704), the antenna canopy suppresses the RF signal level propagating through the upper side lobes of the base station antenna from the received set of RF signals. At step (706), the filtered set of RF signals are transmitted to one or more far end cell sites. At step (708), the processor may detect an antenna electrical and main lobe radiation pattern of the suppressed set of RF signals.

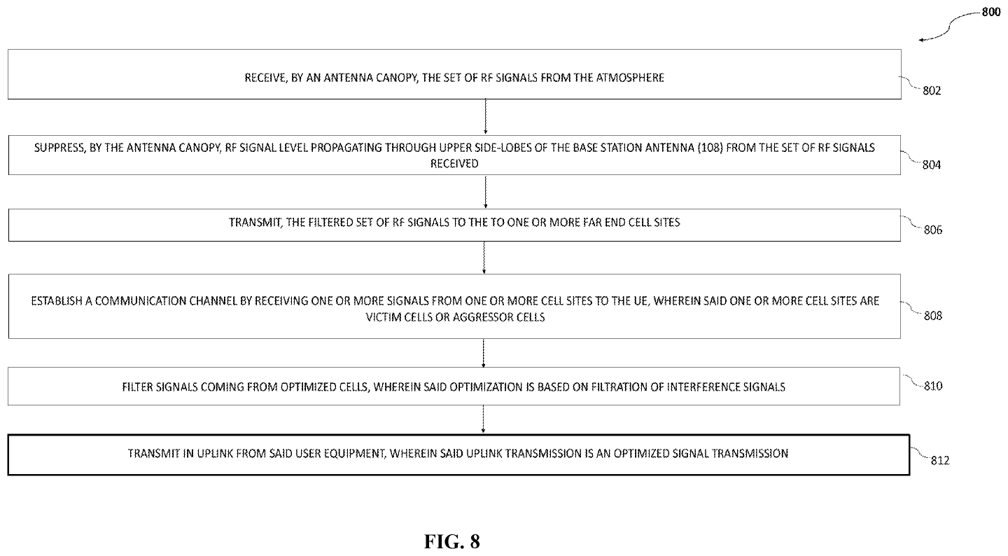

FIG. 8 illustrates a flow chart of the process at UE for uplink transmission of optimized signal, in accordance with an embodiment of the present disclosure.

At step (802), an antenna canopy is configured to receive a set of RF signals from the atmosphere. At step (804), the antenna canopy suppresses the RF signal level propagating through the upper side lobes of the base station antenna from the received set of RF signals. At step (806), the filtered set of RF signals are transmitted to one or more far end cell sites. At step (8108), the UE establishes a communication channel by receiving one or more signals from one or more cell sites. The one or more cell sites may be victim cells or aggressor cells. At step (810), filtering signals coming from optimized cells, wherein said optimization is based on filtration of interference signals. At step (810), the UE transmits in uplink. Further the uplink transmission is an optimized signal transmission.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### Advantages of the Present Disclosure

The present disclosure provides an antenna canopy that will diminish the Tropospheric duct interference.

The present disclosure provides an antenna canopy that will significantly reduce the Upper and grating lobes of the antenna and thereby reduce the amount of RF signal or power entering into duct region.

The present disclosure provides a system that prevents degradation in the antenna electrical and main lobe radiation pattern performance with Canopy structure.

The present disclosure provides an antenna canopy structure that is easy to install on the top of the antenna without any additional mounting bracket gear.

The present disclosure provides an antenna canopy structure that requires no demounting of the base station antenna on the tower for installing the antenna canopy.

The present disclosure provides an antenna canopy structure that has no additional effect of wind load on tower.

The present disclosure provides an antenna canopy structure that minimizes the weight of the antenna canopy structure.

The present disclosure provides an user equipment, which consumes less power during uplink transmission.

We claim:

1. A system (110) for reducing network self-interference, said system (110) comprising:
an antenna canopy (114), said antenna canopy (114) mounted on top of a base station antenna (108) for receiving and transmitting a set of radio frequency (RF) signals to one or more far end cell sites;
one or more computing devices (104), said one or more computing devices (104) operatively coupled to one or more processors (202), said one or more processors (202) operatively coupled to the antenna through a network (106), wherein the one or more processors (202) is further coupled with a memory (204), the memory stores instructions which when executed by the one or more processors (202), causes the system (110) to:
receive, by an antenna canopy (114), the set of RF signals from the atmosphere;
suppress, by the antenna canopy (114), RF signal level propagating through upper side-lobes of the base station antenna (108) from the set of RF signals received;
transmit, the filtered set of RF signals to the to one or more far end cell sites; and
detect, by one or more processors (202), an antenna electrical and main lobe radiation pattern of the suppressed set of RF signals.

2. The system (110) as claimed in claim 1, wherein the system (110) is further configured to reduce upper and grating lobes of the base station antenna (108) to prevent an amount of an RF signal entering into a duct region of the atmosphere without degradation in the Antenna Electrical and Main lobe radiation pattern.

3. The system as claimed (110) in claim 1, wherein the system (110) is further configured to identify, by the one or more processors (202), one or more aggressor cells and one or more victim cells.

4. The system (110) as claimed in claim 3, wherein the system (110) is further configured to alleviate interference in the one or more aggressor cells.

5. The system (110) as claimed in claim 4, wherein the system (110) is further configured to reduce the number of victim cells based on the alleviation of interference in the one or more Aggressor cells without affecting traffic and user throughput.

6. The system (110) as claimed in claim 1, wherein the system (110) is configured to reduce a Tropospheric interference permanently.

7. An antenna canopy (114) for reducing network self-interference, said antenna canopy (114) comprising:
a mounting bracket (304), the mounting bracket (304) comprising of one or more structures to mount the mounting bracket on top of a base station antenna (108), wherein the mounting bracket (304) is of a predefined shape and size;
a metal frame (302) connected in the inner sides of the mounting bracket (304);
a metal sheet (116), the metal sheet (116) configured to be attached to the metal frame (302), wherein the metal sheet comprises a plurality of cut outs (118) of a predefined shape, wherein the plurality of cut outs (118) are spread out periodically, and wherein the plurality of cut outs (118) are designed as a mesh type structure such that one or more predefined frequencies of a set of RF signals that cause interference in the set of RF signals are filtered by the plurality of cut outs (118).

8. The antenna canopy (114) as claimed in claim 7, wherein filtering by the plurality of cut outs (118) reduces a sidelobe or grating lobe power level that ceases a leakage of an RF signal into a duct region of the atmosphere.

9. The antenna canopy (114) as claimed in claim 7, wherein the antenna canopy (114) is attachable or detachable without having to demount the base station antenna (108).

10. The antenna canopy (114) as claimed in claim 7, wherein the mesh type structure prevents additional effect of wind on the base station antenna (108).

11. The antenna canopy (114) as claimed in claim 7, wherein the mesh type structure minimizes weight of the antenna canopy (114).

12. The antenna canopy (114) as claimed in claim 7, wherein the predefined shape of the plurality of cut outs (118) are square, diamond, hexagonal, circular, parallelogram, and L shaped.

13. A user equipment (104-1-n), wherein said user equipment comprising:
a processor (202);
a memory (204);
a network antenna (108) in said user equipment (UE), wherein said network antenna is configured to establish a communication channel by receiving one or more signals from one or more cell sites to said UE, wherein said one or more cell sites are victim cells or aggressor cells;
a receiver in said user equipment, wherein said receiver is configured to adapt filtered signals coming from optimized cells, wherein said optimization is based on filtration of interference signals; and
a transmitter, configured for uplink transmission from said user equipment, wherein said uplink transmission is an optimised signal transmission.

14. A non-transitory computer-readable medium comprising processor-executable instructions that cause a processor to:
receive a set of radio frequency (RF) signals from an atmosphere;
suppress RF signal level propagating through upper side-lobes of a base station antenna (108) from the set of RF signals received;
transmit the filtered set of RF signals to one or more far end cell sites; and
detect an antenna electrical and main lobe radiation pattern of the suppressed set of RF signals.
